(19) United States
(12) Patent Application Publication
(10) Pub. No.: US 2008/0196030 A1
(43) Pub. Date: Aug. 14, 2008

(54) OPTIMIZING MEMORY ACCESSES FOR MULTI-THREADED PROGRAMS IN A NON-UNIFORM MEMORY ACCESS (NUMA) SYSTEM

(76) Inventors: William M. Buros, Austin, TX (US); Kevin Xing Lu, Brooklyn, NY (US); Santhosh Rao, Austin, TX (US); Peter Wai Yee Wong, Austin, TX (US)

Correspondence Address: IBM CORP (YA);C/O YEE & ASSOCIATES PC, P.O. BOX 802333, DALLAS, TX, 75380, US

(21) Appl. No.: 11/674,278

(22) Filed: Feb. 13, 2007

(51) Int. Cl. G06F 9/46

(52) U.S. Cl. 718/102; 711/E12.001

(57) ABSTRACT

A computer implemented method, apparatus, and computer program product for optimizing a non-uniform memory access system. Each thread in a set of threads is affinitized to a processor in a set of processors at different times to form a temporarily affinitized thread, wherein a single temporarily affinitized thread is present. The set of threads execute on the set of processors to perform one or more tasks each time the temporarily affinitized thread is formed. Information is collected about memory accesses by the temporarily affinitized thread. Based on the collected information about the memory accesses, at least one thread in the set of threads is permanently affinitized to a processor in the set of processors.

### BACKGROUND OF THE INVENTION

1. Field of the Invention

The present invention relates generally to data processing systems and in particular to non-uniform memory access (NUMA) systems. Still more particularly, the present invention relates to a computer implemented method, apparatus, and computer program product for optimizing memory accesses for multi-threaded programs in a non-uniform memory access system.

2. Description of the Related Art

In a symmetric multi-processor (SMP), two or more processing units are physically located in close proximity to each other. For example, the two or more processing units may be constructed on the same circuit board, or even the same integrated circuit package. In addition to the processing units, the symmetric multi-processor also contains other components, including local memory and an internal bus. In a non-uniform memory access system, two or more symmetric multi-processors are connected to an external bus. A symmetric multi-processor uses the internal bus to communicate with other symmetric multi-processors, and with external devices.

The processing unit within a symmetric multi-processor can access memory within the same symmetric multi-processor at a relatively fast speed because the memory is local to the symmetric multi-processor. The processing unit within a symmetric multi-processor can access memory in other symmetric multi-processors at a relatively slow speed because the memory is remote to the symmetric multi-processor. Because the time to access memory varies depending on whether the memory is local or remote, the system is called a non-uniform memory access system.

When a software thread runs on one symmetric multi-processor but frequently accesses remote memory on another symmetric multi-processor, the slower memory accesses result in the software thread executing slowly. In contrast, if a software thread runs on a symmetric multi-processor and most of the memory accesses by the software thread are to local memory, then the software thread is able to execute relatively quickly.

### SUMMARY OF THE INVENTION

The illustrative embodiments described herein provide a computer implemented method, apparatus, and computer program product for optimizing a non-uniform memory access system. Each thread in a set of threads is affinitized to a processor in a set of processors at different times to form a temporarily affinitized thread, wherein a single temporarily affinitized thread is present. The set of threads execute on the set of processors to perform one or more tasks each time the temporarily affinitized thread is formed. Information is collected about memory accesses by the temporarily affinitized thread. Based on the collected information about the memory accesses, at least one thread in the set of threads is permanently affinitized to a processor in the set of processors.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a block diagram of a symmetric multi-processor in accordance with an illustrative embodiment;

FIG. 2 is a block diagram of a non-uniform memory access system in accordance with an illustrative embodiment;

FIG. 3 is a block diagram of threads in a non-uniform memory access system in accordance with an illustrative embodiment;

FIG. 4 is a table of rankings for local memory accesses by child threads in accordance with an illustrative embodiment; and

FIG. 5 is a flowchart of a process for optimizing threads in accordance with an illustrative embodiment.

### DETAILED DESCRIPTION OF THE PREFERRED EMBODIMENT

In a symmetric multi-processor (SMP), a set of processing units are physically located in close proximity to each other, wherein the set has two or more processing units. For example, the set of processing units may be constructed on the same circuit board, or even in the same integrated circuit package. In addition to the processing units, the symmetric multi-processor also contains other components, including local memory and an internal bus.

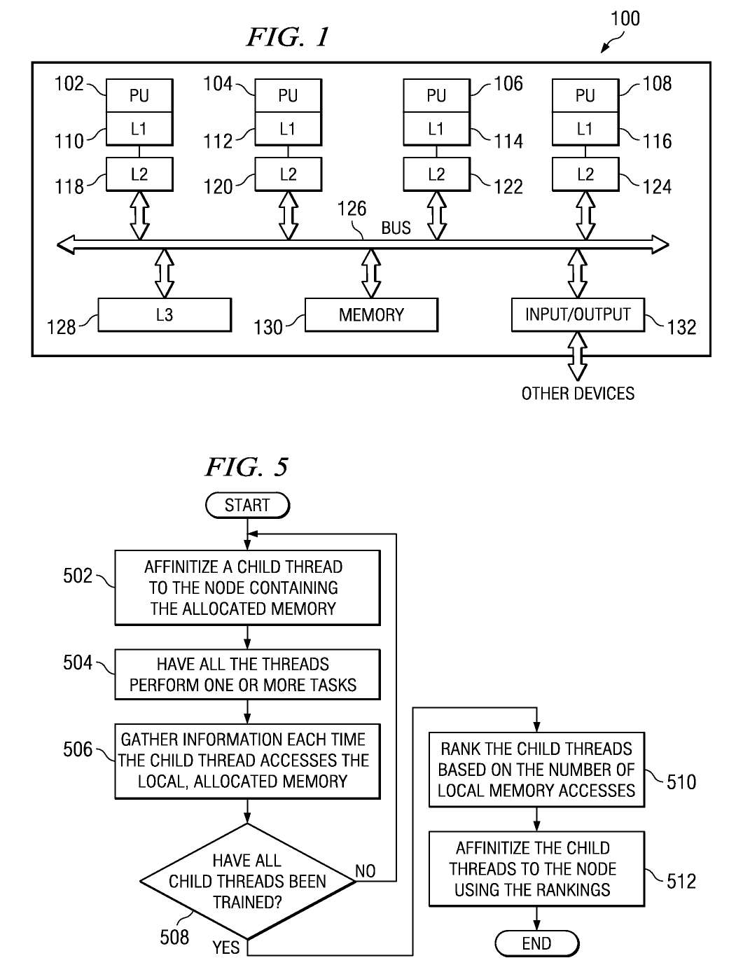

FIG. 1 is a block diagram of a symmetric multi-processor in accordance with an illustrative embodiment. In this example, symmetric multi-processor 100 has four processing units, processing units 102, 104, 106, and 108. One or more cache memories are often used in conjunction with processing units to reduce the average time to access main memory. The cache memory is a small, fast memory which stores copies of the most frequently used data from main memory.

Many processing units use multiple levels of cache, with small fast caches backed up by larger, slower caches. The cache closest to the processing unit, which is usually the fastest cache, is sometimes called the level one cache. A larger and slower cache, which is located farther away from the processing unit, is called the level two cache. Some processing units have a third cache as well, called the level three cache, which is located still farther away from the processing unit.

In this example, processing units 102, 104, 106, and 108 each have an associated level one cache, L1 110, L1 112, L1 114, and L1 116, respectively. Processing units 102, 104, 106, and 108 each have an associated level two cache, L2 118, L2 120, L2 122, and L2 124, respectively.

Symmetric multi-processor 100 has an internal bus, bus 126, to which the four processing units 102, 104, 106, and 108 are connected through their respective level one caches, L1 110, L1 112, L1 114, and L1 116, and level two caches, L2 118, L2 120, L2 122, and L2 124. Connected to bus 126 are level three cache L3 128, memory 130, and input/output 132. Memory 130 is the main memory in which data is stored. Level three cache L3 128 stores data from memory 130 which is frequently accessed. Input/output 132 is used by processing units 102, 104, 106, and 108 to communicate with devices external to symmetric multi-processor 100.

In a non-uniform memory access system, two or more symmetric multi-processors are connected to an external bus. A symmetric multi-processor uses the bus to communicate with other symmetric multi-processors, and with external devices.

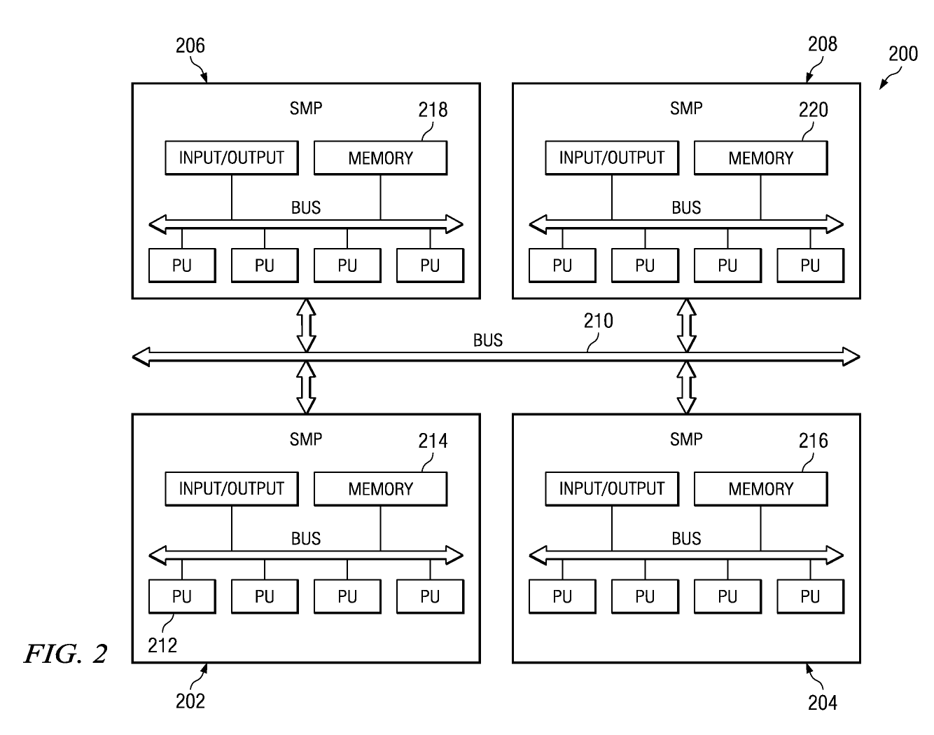

FIG. 2 is a block diagram of a non-uniform memory access system in accordance with an illustrative embodiment. In non-uniform memory access 200, four symmetric multi-processors, SMP 202, SMP 204, SMP 206, and SMP 208 are connected to a common, external bus, bus 210. SMP 202, SMP 204, SMP 206, and SMP 208 are symmetric multi-processors, such as symmetric multi-processor 100 in FIG. 1.

As previously discussed, each symmetric multi-processor may have four processing units, an internal bus, memory, and three levels of cache. However, the three levels of cache, level one, level two, and level three, in each symmetric multi-processor are not shown to simplify the number of components shown in FIG. 2.

When a processing unit in one symmetric multi-processor accesses memory in the same symmetric multi-processor, the memory access is relatively fast because the memory is local. When a processing unit in one symmetric multi-processor accesses memory in another symmetric multi-processor, the memory access is relatively slow because the memory is remote. Therefore, memory access is non-uniform because the speed of the memory access depends on whether the memory access is local or remote.

For example, assume processing unit 212 accesses memory 214. Because both processing unit 212 and memory 214 are located within symmetric multi-processor SMP 202, the memory access is relatively fast because the memory access is local. In contrast, suppose processing unit 212 accesses memory 216. Because processing unit 212 is located in symmetric multi-processor SMP 202, while memory 216 is located in a different symmetric multi-processor, SMP 204, the memory access is relatively slow because the memory access is remote. Similarly, if processing unit 212 accesses memory 218 in symmetric multi-processor 206 or memory 220 in symmetric multi-processor 208, the memory access is relatively slow.

A thread is an instance of a software program performing a specific task. A software program that can have multiple threads is called a multi-threaded program. On a single processor system, multiple threads can be executed using time-slicing, in which the processor executes each thread, in turn, for a brief period of time, giving the illusion that the multiple threads are executing simultaneously.

On a multiprocessor system, multiple threads can be executed in parallel, simultaneously on different processing units. In a multiprocessor system, such as symmetric multi-processor SMP 202, each processing unit can execute a thread. A thread executing on one processing unit can typically access local memory faster than the thread can access remote memory.

It is common for a thread to spawn one or more threads. The thread spawning one more threads is called the parent, while the spawned threads are called a set of child threads. A child thread typically performs a task for the parent thread, and after completing the task, the child thread disappears from the system. A parent thread may have multiple child threads performing various tasks at the same time.

Generally, the parent thread allocates a portion of the local memory for use by the parent thread and the child threads. When the parent thread spawns a set of child threads in a non-uniform memory access system, some of the child threads may run on a different symmetric multi-processor than the parent. Often, the child threads access the portion of local memory which the parent thread initially allocated. If the child thread runs on a symmetric multi-processor other than the symmetric multi-processor the parent thread is on, then the child thread must access remote memory. A remote memory access takes longer than a local memory access.

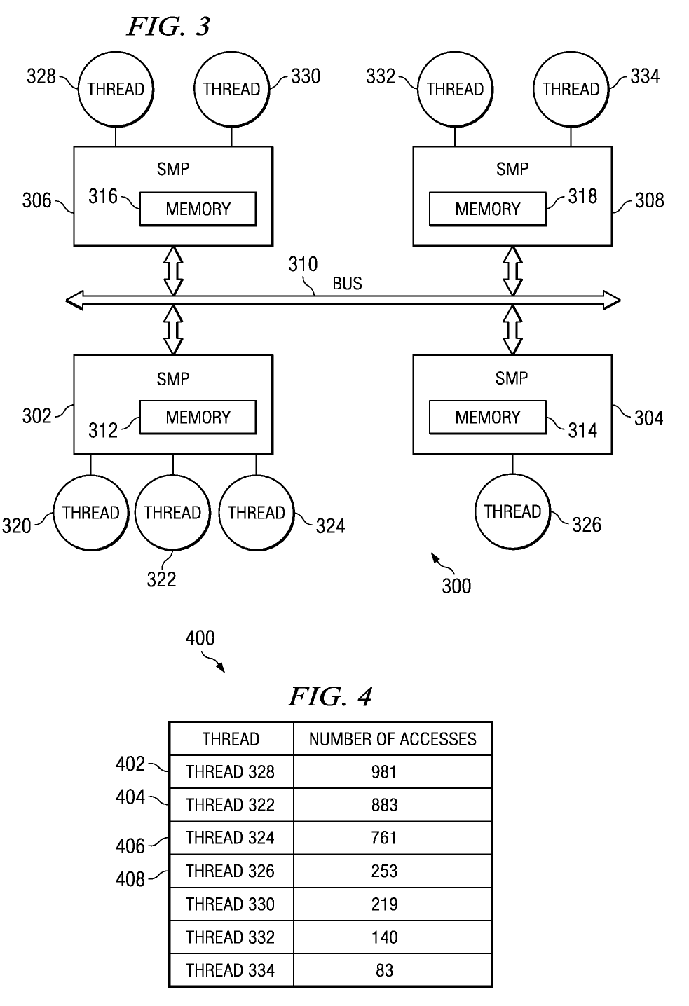

FIG. 3 is a block diagram of threads in a non-uniform memory access system in accordance with an illustrative embodiment. FIG. 3 illustrates a non-uniform memory access system before the system has been optimized. For threads in non-uniform memory access system 300, four symmetric multi-processors, SMP 302, SMP 304, SMP 306, and SMP 308 are connected to an external bus, bus 310. Each symmetric multi-processor has its own local memory. SMP 302 has memory 312, SMP 304 has memory 314, SMP 306 has memory 316, and SMP 308 has memory 318.

One or more threads run on each symmetric multi-processor. In this example, threads 320, 322, and 324 run on SMP 302, thread 326 runs on SMP 304, threads 328 and 330 run on SMP 306, and threads 332 and 334 run on SMP 308. When threads 320, 322, or 324 access memory 312, the memory access is relatively fast because memory 312 is local to SMP 302. However, when threads 320, 322, or 324 access memories 314, 316 or 318, the memory access is relatively slow because the memory access is remote.

In FIG. 3, assume that thread 320 is the parent thread, and threads 322 and 334 are child threads spawned from parent thread 320. Assume that parent thread 320 allocates memory from memory 312. For child threads 322 and 324, memory 312 is local, but for threads 326-334, memory 312 is remote.

The embodiments recognize that it would be useful if the child threads which most often access a memory located in a symmetric multi-processor had an affinity to run on that symmetric multi-processor. A thread has an affinity for a processor if the thread has a preference to run on the processor whenever possible. When a thread has an affinity for a processor, the thread is affinitized to that processor. By determining the memory each child thread accesses, each thread can be affinitized so that the majority of memory accesses which the thread performs are local.

The illustrative embodiments described herein provide a computer implemented method, apparatus, and computer program product for optimizing a non-uniform memory access system. Each thread in a set of threads is affinitized to a processor in a set of processors at different times to form a temporarily affinitized thread, wherein a single temporarily affinitized thread is present. The set of threads execute on the set of processors to perform one or more tasks each time the temporarily affinitized thread is formed. Information is collected about memory accesses by the temporarily affinitized thread. Based on the collected information about the memory accesses, at least one thread in the set of threads is permanently affinitized to a processor in the set of processors.

For example, if child thread 326 has the most local memory accesses of all the child threads when temporarily affinitized to SMP 302 during training, then child thread 326 can later be permanently affinitized to SMP 302 in the production run to improve performance. Permanently affinitizing child thread 326 to SMP 302 in the production run results in child thread 326 accessing memory 312 as local memory instead of remote memory. Performance is improved when child thread 326 is permanently affinitized to SMP 302 because accessing memory 312 is local, and therefore faster than accessing remote memory.

To optimize the child threads, the child threads in the non-uniform memory access system are trained. Training is the process of (1) temporarily affinitizing a child thread to the node containing the memory allocated by the parent node, (2) having the thread perform tasks, and (3) gathering data on the number of local memory accesses performed by the child thread when performing the tasks. The process is repeated for each child thread so that each child thread is trained.

Once each child thread has been trained, the data gathered contains various data, including the number of local memory accesses for each child thread during each training run. By ranking the child threads based on the number of local memory accesses during training, the child threads with the most local memory accesses may be permanently affinitized to the node containing the memory allocated by the parent node.

Typically, the rankings are used to permanently affinitize the N highest ranked threads, where N is an integer specified by the user. For example, if there are fifteen child threads, all fifteen are trained and ranked, and then only the top three child threads are permanently affinitized to the node containing the allocated memory. The number of child threads permanently affinitized to the node containing the allocated memory depends on a variety of factors, such as the total number of threads in the system, the maximum number of threads which may run on a node, and whether there is a significant drop off in memory accesses between one of the high ranking child threads and the lower ranked threads.

During training, the child threads typically perform the most common tasks performed by the child threads in the system. Those versed in the art will appreciate that the child threads may be optimized for performing any specific tasks the user wishes. This example illustrates training individual child threads, but the same process may be applied to groups of child threads instead of individual child threads. Those versed in the art will appreciate that in a system with many child threads, the child threads may be grouped together and trained as a group rather than individually.

In FIG. 3, child threads 322-334 are trained as follows. Child thread 322 is temporarily affinitized to SMP 302 and threads 324-334 are temporarily affinitized to run on SMP 304, SMP 306, and SMP 308, respectively. All the child threads are given tasks to perform and data about memory accesses is gathered, including the number of local memory accesses by temporarily affinitized thread 322. The previous steps are then repeated for each child thread until each child thread has been temporarily affinitized to SMP 302.

Once each child thread has been temporarily affinitized to the node containing the memory allocated by the parent thread, the child threads are ranked based on the number of local memory accesses when the child thread was affinitized to the node containing the allocated memory. The threads with the highest number of local memory accesses are then permanently affinitized to the node with the allocated memory in order to optimize memory accesses.

FIG. 4 is a table showing the rankings for local memory accesses by child threads in accordance with an illustrative embodiment. Assume that the information in FIG. 4 was produced as a result of performing a training run for child threads 322-334 in FIG. 3. The information gathered during training has been ranked based on the number of local memory accesses.

In FIG. 3, thread 320 is the parent thread, and so the training is performed using SMP 302 because parent thread 320 has allocated a portion of memory 312. In table of thread memory accesses 400, row 402 indicates that child thread 328 accessed local memory 312 981 times during the training. 981 was the maximum number of local memory accesses performed by an individual child thread. Row 404 indicates that child thread 322 accessed local memory 312 883 times during the training, and 883 was the second highest number of local memory accesses by a thread. Similarly, row 406 indicates that thread 324 accessed local memory 312 761 times.

Row 408 indicates that thread 326 accessed local memory 312 253 times. Because of the sharp drop off between the number of local memory accesses for child thread 324 and child thread 326, in this example, the top three child threads, 328, 322, and 324, may be optimized in order to optimize system performance by minimizing the number of remote memory accesses.

Non-uniform memory access system 300 in FIG. 3 is optimized by affinitizing child threads 328, 322, and 324 to symmetric multi-processor SMP 302, because parent thread 320 has allocated a portion of memory 312. By affinitizing threads 328, 322, and 324 to SMP 302, most of the memory accesses to memory 312 become local instead of remote, making memory access faster. When memory access is faster, the child threads can execute faster, resulting in the parent thread executing faster.

FIG. 5 is a flowchart of a process for optimizing threads in accordance with an illustrative embodiment. The process shown in FIG. 5 is executed by a thread, such as thread 320 in FIG. 3.

The process begins by temporarily affinitizing a child thread to the node containing the memory allocated by the parent node (step 502). All the threads, parent and child threads, perform a set of one or more tasks (step 504). Typically, the tasks performed during training are tasks that are commonly performed in the system so that the system can be optimized for the most commonly performed set of tasks.

Information is gathered about the number of local memory accesses performed by the child thread (step 506). Those versed in the art will appreciate that other information may be gathered in addition to, or instead of the information mentioned, in order to optimize the system. The information gathered may be for a specified criterion, such as a specific amount of time, or for a specified amount of memory accesses.

A determination is made as to whether all the child threads have been trained (step 508). If the answer is “no”, then the process repeats in step 502 with affinitizing a different thread.

If the answer is “yes”, and each child thread has been affinitized to the node containing the memory allocated by the parent thread, then the information gathered is analyzed and child threads are ranked based on the number of memory accesses (step 510). The child threads are then affinitized to the symmetric multi-processor nodes containing the memory allocated by the parent thread (step 512), and the process ends thereafter. As previously mentioned, only the top N threads are affinitized, where N is a user determined integer.

Steps 502-510 comprise the training run, in which the threads are trained and ranked before the system is put into normal use. Step 512 is the production run, in which the system is optimized by affinitizing the child threads with the most local memory accesses. After step 512, the system is put into normal use and used to perform the tasks it was designed to perform.

The illustrative embodiments described herein provide a computer implemented method, apparatus, and computer program product for optimizing a non-uniform memory access system. Each thread in a set of threads is affinitized to a processor in a set of processors at different times to form a temporarily affinitized thread, wherein a single temporarily affinitized thread is present. The set of threads execute on the set of processors to perform one or more tasks each time the temporarily affinitized thread is formed. Information is collected about memory accesses by the temporarily affinitized thread. Based on the collected information about the memory accesses, at least one thread in the set of threads is permanently affinitized to a processor in the set of processors.

The flowcharts and block diagrams in the different depicted embodiments illustrate the architecture, functionality, and operation of some possible implementations of methods, apparatuses, and computer program products. In this regard, each block in the flowchart or block diagrams may represent a module, segment, or portion of code, which comprises one or more executable instructions for implementing the specified function or functions. In some alternative implementations, the function or functions noted in the block may occur out of the order noted in the figures. For example, in some cases, two blocks shown in succession may be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for optimizing a non-uniform memory access system, the computer implemented method comprising:
affinitizing each thread in a set of threads to a processor in a set of processors at different times to form a temporarily affinitized thread, wherein a single temporarily affinitized thread is present;
executing the set of threads on the set of processors to perform one or more tasks each time the temporarily affinitized thread is formed;
collecting information about memory accesses by the temporarily affinitized thread to form collected information; and
permanently affinitizing at least one thread in the set of threads to a processor in the set of processors based on the collected information about the memory accesses.

2. The computer implemented method of claim 1, wherein the temporarily affinitized thread causes the thread to temporarily have a preference to execute on the processor.

3. The computer implemented method of claim 1, wherein the step of permanently affinitizing the at least one thread causes the at least one thread to permanently have a preference to execute on the processor.

4. The computer implemented method of claim 1, further comprising:
causing the at least one thread to execute on the processor.

5. The computer implemented method of claim 1, wherein the processor is a symmetric multi-processor and wherein the set of processors comprises two or more symmetric multi-processors.

6. The computer implemented method of claim 1, wherein the collected information indicates the at least one thread accesses memory which is local to the processor.

7. A non-uniform memory access system comprising:
a bus;
a storage device connected to the bus, wherein the storage device contains computer usable code;
a communications unit connected to the bus; and
a set of symmetric multi-processors connected to the bus for executing the computer usable code, wherein, for each thread in a set of threads, the thread is temporarily affinitized to a processor in the set of symmetric multi-processors, the set of threads simultaneously perform one or more tasks, information about memory accesses by the thread is collected, and at least one thread in the set of threads is permanently affinitized to a symmetric multi-processor in the set of symmetric multi-processors based on the information about the memory accesses.

8. A computer program product comprising a computer usable medium including computer usable program code for optimizing a non-uniform memory access system, the computer program product comprising:
computer usable code for affinitizing each thread in a set of threads to a processor in a set of processors at different times to form a temporarily affinitized thread, wherein a single temporarily affinitized thread is present;
computer usable code for executing the set of threads on the set of processors to perform one or more tasks each time the temporarily affinitized thread is formed;
computer usable code for collecting information about memory accesses by the temporarily affinitized thread to form collected information; and
computer usable code for permanently affinitizing at least one thread in the set of threads to a processor in the set of processors based on the collected information about the memory accesses.
